(19) United States
(12) Patent Application Publication
(10) Pub. No.: US 2004/0120886 A1
(43) Pub. Date: Jun. 24, 2004

(54) Chlorine treatment for producing alumina ceramics with low transition metal impurities

(75) Inventors: Joseph J. Shiang, Niskayuna, NY (US); James A. Brewer, Scotia, NY (US); Charles D. Greskovich, Schenectady, NY (US); Victor L. Lou, Schenectady, NY (US)

Correspondence Address: Scott A. McCollister, FAY, SHARPE, FAGAN, MINNICH & McKEE, LLP, Seventh Floor, 1100 Superior Avenue, Cleveland, OH, 44114, US

(73) Assignee: GENERAL ELECTRIC COMPANY, Schenectady, NY

(21) Appl. No.: 10/325,558

(22) Filed: Dec. 20, 2002

(51) Int. Cl. C01F 7/02

(52) U.S. Cl. 423/625

(57) ABSTRACT

The present invention relates to polycrystalline alumina ceramics having low transition metal impurities and methods for producing the same.

### BACKGROUND OF THE INVENTION

1. Field of the Invention

The present invention relates to polycrystalline alumina ceramics having low transition metal impurities and methods for producing the same.

2. Discussion of the Art

Polycrystalline alumina (PCA) is in many respects an ideal arc tube material for lighting applications. It is made from inexpensive starting materials (powdered alumina and organic binders) and formed into its final high density/low porosity state using low-cost fabrication techniques suitable for mass production. The PCA arc tube has a high melting point of ˜2050° C., is resistant to chemical attack by sodium, mercury and metal halide vapors in high intensity discharge lamps and has low intrinsic optical absorption of lamp light. A wide variety of useful shapes of PCA can be formed from alumina powders by such methods as die/isostatic-pressing, extrusion, injection molding, tape casting and slurry and/or gel casting.

PCA parts are typically consolidated by heat treatment processors, such as sintering, hot pressing and hot isostatic (gas) pressing that produce strong, optically translucent parts with very low residual porosity. Light scattering in this material arises primarily from residual porosity and anisotropy in the indices of refraction in alumina. Because the c-axis of the material has an index different from that a-axis of the hexagonal alumina crystal, there is usually a mismatch in refractive index at each grain boundaries in the polycrystalline ceramic. This index mismatch causes incident light to scatter to some other angles. The net effect is the optical path length of light traveling in the material is increased. In many PCA products in use, the remaining pores cause a substantial amount of light scattering and also result,in increased optical path length of traveling light. Increasing the path length of the material amplifies the effect of light loss due to optical absorption by impurities, particularly transition metal impurities in trace amounts. These impurities are introduced either from the starting powder, or during the processing steps which form the material into its final shape. In lighting applications, these losses directly affect the light output of the complete lamp. For optimal performance of PCA, the concentration of transition metal impurities should be reduced to an absolute minimum for the intended application.

With respect to techniques used to produce PCA ceramics, Coble (U.S. Pat. No. 3,026,210) discloses the production of translucent polycrystalline alumina ceramics. Zuk (U.S. Pat. No. 5,587,346) and Charles, et al. (U.S. Pat. No. 4,285,732) each disclose the use of other additives to reduce light scattering and thus increase light transmission in the polycrystalline ceramic. Removal of iron impurities from solid silica materials is also known from, for example, Yamada, et al. (U.S. Pat. No. 6,133,178).

A need still exists for the removal of transition metal impurities, such as iron, from alumina based ceramics in order to enhance the light transmission properties thereof.

### BRIEF SUMMARY OF THE INVENTION

The present invention is directed to the removal of transition metal impurities from alumina based ceramics. Removal of such transition metal impurities enhances and improves light transmission properties of translucent/transparent polycrystalline alumina (PCA) products formed therefrom. This is accomplished because the transition metal impurities cause light absorption when present in transparent/translucent PCA products, such as in lighting devices.

According to a first aspect of the invention, transition metal impurities are removed from alumina by treating a porous, bisque-fired alumina part with a gas mixture containing chlorine gas at a temperature which is sufficient to cause the transition metal to volatize. Typically, the temperature will range from about 900° C. to about 1000° C. Transition metal impurities present in the alumina which form a volatile halide species at these temperatures are removed to very low concentrations by this treatment (e.g., Fe, Cr., Ta, Nb, Mo, W, . . . ).

According to another aspect of the invention, a transition metal impurity is removed from a loose alumina powder by treatment of the alumina powder with a gas mixture that contains chlorine gas at a temperature sufficient to volatize the transition metal. This temperature is typically between 900° C. and 1000° C.

In yet another aspect of the invention, a transition metal impurity is removed from a loose alumina powder or open porosity ceramic part by treatment of the alumina powder with thionyl chloride followed by heating to about 900° C.

A further aspect of the invention relates to increasing the light transmission of a polycrystalline arc tube by exposing the polycrystalline arc tube, in an open porosity state, to chlorine gas. The chlorine gas reacts with transition metal, such as iron, which may be present in the polycrystalline tube due to the mold from which it was made in. Upon heating the open porosity PCA tube in the presence of the chlorine gas, the transition metal forms a transition metal halide with the chlorine gas, dissipates through the open pores of the structure and finally volatilizes out of the alumina material.

A further aspect of the invention relates to transparent/translucent products produced by the treatment methods of the invention. The products produced by the methods of the invention have reduced amounts of transition metals present (such as iron) compared to untreated products. As such the products have superior light transmission properties compared to untreated products when formed into lighting devices.

An additional aspect of the invention relates to polycrystalline alumina having reduced amounts of transition metals after being treated according to the methods of the invention when compared to untreated polycrystalline alumina.

These and other aspects and objects of the invention will become apparent upon reading and understanding the detailed description of the invention.

### DETAILED DESCRIPTION OF THE INVENTION

A polycrystalline alumina with very low transition metal impurities was obtained via treatment of the “green” alumina ceramic with chlorine while the ceramic is still in an “open porosity” state. The “open porosity” state is defined as consisting of a loosely compacted powder, or a compact, in which the prevailing ambient gas is able to migrate into the compact through the interior pores. Upon heating and treatment with chlorine, transition metal impurities inside the material structure react with the chlorine gas to form volatile metal halides that migrate outwards through the open porosity structure and into the ambient environment. Thus transition metals are removed from the treated ceramic.

According to a first aspect of the invention, transition metal impurities are removed from alumina by treating a porous, bisque-fired alumina part with a gas mixture containing chlorine gas at a temperature which is sufficient to cause the transition metal to volatize. Typically, the temperature will range from about 900° C. to about 1000° C. Transition metal impurities present in the alumina which form a volatile halide species at these temperatures are removed to very low concentrations by this treatment (e.g., Fe, Cr., Ta, Nb, Mo, W, . . . ).

According to another aspect of the invention, a transition metal impurity is removed from a loose alumina powder by treatment of the alumina powder with a gas mixture that contains chlorine gas at a temperature sufficient to volatize the transition metal. This temperature is typically between about 900° C. and about 1000° C. A loose powder has a low packing density, i.e. high porosity, which enhanced the removal of transition metal halides from the alumina. The advantages of using reaction temperatures between about 900° C. and 1000° C. are (1) essentially no reaction between the chlorine gas and the alumina powder nor the typical MgO sintering aid and (2) furnaces with fused silica tubes and parts can be used for processing the alumina powder in the chlorine gas mixture by either purging the furnace with oxygen or with an inert gas, such as nitrogen or argon, or by enabling vacuum pressures down to 1 torr or less before the introduction of the chlorine gas mixture.

In yet another aspect of the invention, a transition metal impurity is removed from a loose alumina powder or open porosity ceramic part by treatment of the alumina powder with thionyl chloride followed by heating to about 900° C.

The chlorine used in the methods of the present invention is useable in the form of a gas or a liquid, such as thionyl chloride. When used in a gaseous state, the chlorine gas need not be pure Cl₂ gas (100%) but may be present in a reduced amount. An effective amount of Cl₂ gas is generally in a range of from about 0.1% to about 15%. More particularly, the Cl₂ gas is present in an amount of about 5%. The chlorine gas may be in a mixture with, for example, inert gasses such as nitrogen or argon.

The amount of transition metal present in alumina which has been treated according to the invention is an amount which is reduced compared to an untreated control. Typically, the amount of the transition metal impurity in treated alumina is less than about 10 ppm. Preferably, the amount of transition metal in treated alumina is less than about 5 ppm. More preferably, the amount of transition metal impurity in treated alumina is less than about 3 ppm.

The temperatures at which the treatment of the invention takes place is generally that which is sufficient to cause the transition metal to volatize but yet causes no significant reaction between chlorine and either the alumina material or the sintering aid(s) such as MgO. Typically, this temperature is between the range of about 900° C. and 1000° C. although higher or lower temperatures may be employed depending upon the volatization temperature of the transition metal impurity present in the alumina.

The amount of time required for exposure of the alumina to the chlorine gas at the volatization temperature of the transition metal impurity is generally that which is sufficient to cause formation of volatile halide species of the transition metals and their permeation/removal from the alumina. A period of about two hours is generally sufficient for this to take place although this time may be increased or decreased depending upon the transition metal and how much of it is present amongst other factors (concentration of chlorine, atmosphere pressure, etc.).

The following experimental data has been generated to exemplify the invention. However, it is not intended to be further limiting thereof.

### Experimental

PCA arc tubes were fabricated by an injection molding process and sintered to optical translucency. The amount of light loss due to absorption in the material was determined by placing an optical fiber inside an integrating sphere and measuring the total amount of visible light emitted from the sphere both with and without the arc tube covering the fiber. The injection molding process is known to introduce trace (up to 10 ppm.) levels of Fe impurities due to abrasion of the stainless steel mold. These Fe impurities lead to absorption loss when present in the 2⁺ valence state or fully reduced metallic state in the material.

Following injection molding, all arc tubes were fired to remove the wax additive used during the molding process. Seven arc tubes for each sample were treated with dilute (˜5%) Cl₂ gas at both 900° C. and 1000° C. for two hours. Five other arc tubes in each sample remained untreated and served as a control set. Following treatment with Cl₂, the arc tubes were heated in air to remove any residual chlorine bonded to the particle surfaces. Finally, the arc tubes were sintered to optical translucency at a temperature of 1865° C. for five hours in hydrogen gas. The total absorption measurements on the translucent arc tubes indicated that the set of chlorinated arc tubes had significantly (≧6%) higher total transmission than the arc tubes which had not been treatment [control set]. Table 1 gives the transmission results for a number of different samples that were subject to chlorine treatment according to the invention on different days and shows the repeatability of improved optical quality of the chlorine-treated material. The sintered tubes made from non-chlorinated alumina occasionally exhibited a slight gray color as compared to the colorless sintered tubes made from chlorine-treated samples.

Furthermore, elemental analysis of a bisque-fired sample that was chlorine-treated, versus a control sample from the same parent batch but had not been treated, showed a reduction in the level of Fe-impurity from 10 ppm to 3 ppm. In a second set of experiments the chlorine treatment reduced the Fe-impurity from 19.4 to 5.9ppm. It is important to note that during the sintering process from the bisque fired to the nearly fully-dense state, some Fe-impurity in both the Cl-treated and non-treated samples may be lost due to evaporation. Thus, the concentrations of Fe in the final dense ceramic are typically lower.

TABLE 1
Transmittance and Iron Results on Controls and Chlorine-Treated
Arc Tubes [900° C.-1 h]

| | | |
|---|---|---|
| | % Transmittance | |
| Sample | (sintered) | Fe, ppm (Green) |

| | | | |
|---|---|---|---|
| 1 | Control | | 10 |
| | Cl Treated | | 3 |
| 2 | Control | 86 | 19.4 |
| | Cl Treated | 99 | 5.9 |
| 3 | Control | 85 | |
| | Cl Treated | 97 | |
| 4 | Control | 85 | |
| | Cl Treated | 97 | |
| 5 | Control | 82 | |
| | Cl Treated | 97 | |
| 6 | Control | 91 | |
| | Cl Treated | 98 | |

The amount of Fe in the alumina was measured by Glow Discharge Mass Spectrometry (GDMS). GDMS is a sensitive and reliable technique for measuring the transition metal concentration in alumina. The Fe-analysis in alumina processed under various conditions showed the GDMS technique can reliably measure Fe concentrations down to 3 ppm. Consequently, the GDMS technique was used to measure the residual Fe concentration remaining in the selected samples of alumina listed in Table 1.

A metal contained in the alumina material that was not changed by chlorine treatment was Mg, which is critical for controlling grain growth during the sintering operation. This result was confirmed by GDMS with no change in the Mg level before and after the chlorine treatment.

As can be seen from the above experimental data, the treatment of PCA with chlorine gas reduces transition metal impurities, such as iron, which may be present in a PCA product, such as an arc tube. The removal and reduction of the transition metal impurities, in turn, increases the light transmittance properties of the resulting products formed from the PCA which has been treated according to the present invention. This is very valuable in the lighting industry as transparent/translucent ceramic components are traditionally used in lighting devices where optimal transmission of light is highly desirable.

While the invention has been described herein relative to its preferred embodiments, it is of course contemplated that modifications of, and alternatives to, these embodiments, such modifications and alternatives obtaining the advantages and benefits of this invention, will be apparent to those of ordinary skill in the art having reference to this specification. It is contemplated that such modifications and alternatives are within the scope of this invention as subsequently claimed herein.

What is claimed is:

1. A method for removal of transition metal impurities from alumina by exposing the alumina with an open-porosity state to chlorine.

2. The method of claim 1 wherein the chlorine is in a gaseous state.

3. The method of claim 1 wherein the alumina material in an open-porosity state is a porous, bisque-fired alumina ceramic.

4. The method of claim 1 wherein the alumina material with an open-porosity state is alumina powder.

5. The method of claim 1 wherein the exposure of the alumina material in an open porosity state to chlorine takes place at a temperature sufficient to cause the transition metal impurities to volatize.

6. The method of claim 5 wherein the temperature is from about 900° C. to about 1000° C.

7. The method of claim 1 wherein the chlorine is in the form of thionyl chloride.

8. The method of claim 7 wherein after exposure of the alumina ceramic in an open-porosity state to thionyl chloride, it is then heated to about 900° C.

9. A method for removal of transition metal impurities in polycrystalline alumina comprising subjecting a porous, bisque-fired alumina ceramic to a gas which comprises chlorine gas at a temperature which is sufficient to cause the transition metal to volatize thereby forming a volatized transition metal which reacts with the chlorine gas to form metal halides which migrate through and out of the porous alumina part.

10. The method of claim 9 wherein the temperature which is sufficient to cause the transition metal to volatize is from about 900° C. to about 1000° C.

11. The method of claim 9 wherein the gas comprises about 5% chlorine gas.

12. The method of claim 9 wherein the alumina ceramic, is exposed to the chlorine gas for a period of about two hours.

13. The method of claim 10 wherein the alumina ceramic is exposed to the chlorine gas for a period of about two hours.

14. The method of claim 9 wherein after exposing the alumina ceramic part to the chlorine gas, the alumina part is further heated to remove any residual chlorine.

15. The method of claim 14 wherein the alumina ceramic is further sintered to optical transparency.

16. The method of claim 15 wherein the alumina ceramic is a polycrystalline alumina arc tube.

17. A method for increasing the light transmission of a polycrystalline alumina arc tube comprising:
a) forming an open porosity polycrystalline alumina arc tube by an injection molding process;
b) exposure of the polycrystalline tube of step a) to chlorine gas at a temperature of from about 900° C. to about 1000° C. for a period of about two hours;
c) heating the tubes of step b) in air to a temperature sufficient to remove residual chlorine;
d) sintering the tubes of step c) to optical translucency;
wherein the light transmission of the tube of step d) is greater than that of a tube which has not been subject to steps a)-d).

18. A product produced by the method of claim 1.

19. A product produced by the method of claim 9.

20. A product produced by the method of claim 17.

21. Polycrystalline alumina having less than about 10 ppm Fe.

22. The polycrystalline alumina of claim 21 having less than about 5 ppm Fe.

23. The polycrystalline alumina of claim 21 having less than about 3 ppm Fe.
